(19) United States
(12) Patent Application Publication
(10) Pub. No.: US 2010/0300235 A1
(43) Pub. Date: Dec. 2, 2010

(54) Shift Lever Head

(75) Inventors: Daniel Hostmann, Regensburg (DE); Nhu Nguyen Thien, Regensburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/599,788

(22) PCT Filed: Apr. 10, 2008
(86) PCT No.: PCT/EP08/54372

§ 371 Date: Nov. 11, 2009

(30) Foreign Application Priority Data
May 11, 2007 (DE) 102007022086.5

(51) Int. Cl. F16H 59/02; G06F 3/041

(52) U.S. Cl. 74/491; 345/173

(57) ABSTRACT

A shift lever head attached to a free end of a shift lever by the first end region thereof for actuating a transmission of a motor vehicle. A receptacle open toward a second end region opposite the first end region is formed in the shift lever head, an input unit having a touch-sensitive and/or proximity-sensitive input surface being disposed in said receptacle.

### PRIORITY CLAIM

This is a U.S. national stage of application No. PCT/EP2008/054372, filed on Apr. 10, 2008, which claims Priority to the German Application No.: 10 2007 022 086.5, filed: May 11, 2007; the contents of both being incorporated herein by reference.

### BACKGROUND OF THE INVENTION

1. Field of the Invention

The invention relates to a shift lever head that is attached by its first end region to a free end of a shift lever to activate a transmission of a motor vehicle.

2. Prior Art

So that the shift lever head can be easily reached and operated by the driver from the position of the driver seated in the driver's seat, the shift lever and the shift lever head are arranged at a corresponding position in the motor vehicle. The driver can therefore activate the shift lever without changing his sitting position.

To activate input units, it is usually necessary for the driver to bend forward and leave his normal driving position, which leads to increased distraction from the road traffic.

### SUMMARY OF THE INVENTION

An object of the invention is to provide an information input possibility that can easily be reached by the driver from the normal driving position and is suitable for menu-controlled devices.

This object is achieved according to one embodiment of the invention in that a receptacle which is open toward the second end region opposite the first end region is formed in the shift lever head, in which receptacle an input unit with a touch-sensitive and/or proximity-sensitive input surface is arranged.

As a result of this embodiment, the shift lever head is used for the dual function of activating the transmission and of inputting information, in which case the driver can always remain in an optimum driving position, and finding the input surface does not require any particular level of attentiveness on the part of the driver.

The arrangement of the input surface in the second end region means that this region is covered in a protective fashion by the surface of the driver's hand during a transmission shifting operation, with the result that the input surface is not unintentionally activated here and the two modes of activation on the shift lever head also do not interfere with one another.

The use of a touch-sensitive and/or proximity-sensitive input unit permits an information-inputting means which requires only a small amount of space.

In order to increase the protection against incorrect activation of the input surface during a transmission shifting operation, the touch-sensitive and/or proximity-sensitive input surface can be arranged in the receptacle, lying lower by a certain distance from the mouth of the receptacle.

The input unit is preferably a touchpad.

In addition to the function of the inputting of information, the touch-sensitive and/or proximity-sensitive input surface forms a display surface.

To facilitate operation of the input unit in the dark, the touch-sensitive and/or proximity-sensitive input surface or the mouth of the receptacle is surrounded by an illuminated ring.

To secure the input unit in the receptacle, a securing ring can preferably be attached to the mouth of the receptacle, which securing ring surrounds the touch-sensitive and/or proximity-sensitive input surface and rests on the circumferential edge of the input unit in such a way as to secure it in its installation position, with the securing ring being able to perform the dual function of forming the illuminated ring.

To permit further operator control applications, further operator control elements are arranged on the shift lever head and/or the shift lever.

The operator control elements may be used, for example, for an activation function for perpetuating the start of an operator control operation or for switching between different operating modes such as detection of handwriting or a mouse function.

One possible arrangement of an operator control element is for the touch-sensitive and/or proximity-sensitive input surface or the mouth of the receptacle to be surrounded by a pressure ring which forms an operator control component.

In another embodiment, which is also advantageous, keys, which form operator control elements, can be arranged axially and/or radially on the shift lever head.

However, keys, which form operator control elements, can also be arranged radially on the shift lever.

### BRIEF DESCRIPTION OF DRAWINGS

Exemplary embodiments of the invention are illustrated in the drawing and are described in more detail below. In said drawing:

FIG. 1 is a half-cross section of a first exemplary embodiment of a shift lever head along the line I-I in FIG. 2;

FIG. 2 is a plan view of the shift lever head according to FIG. 1; and

FIG. 3 is a plan view of a second exemplary embodiment of a shift lever head.

### DETAILED DESCRIPTION OF THE DRAWINGS

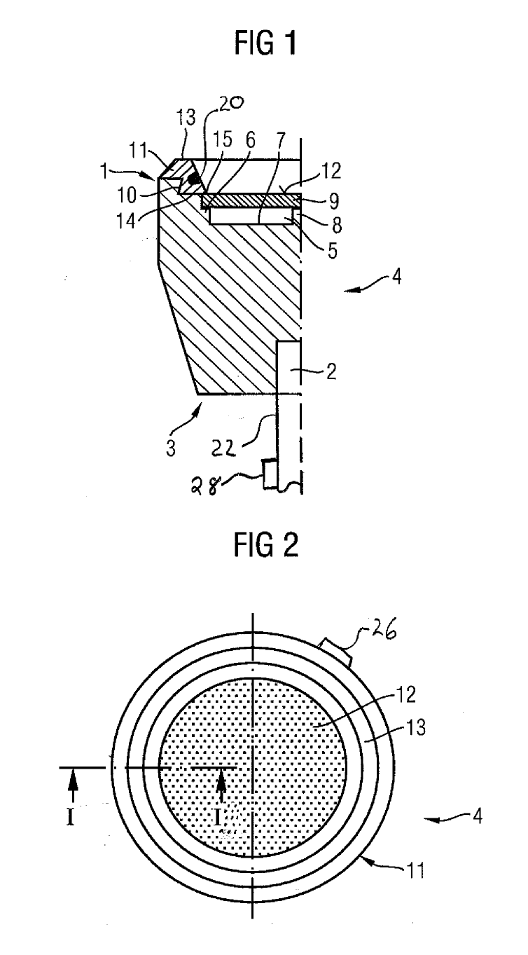

The shift lever heads 4, 4′ which are illustrated in FIGS. 1-3 have a first end region 3 in which a recess 2 for receiving and attaching a shift lever 22 is formed coaxially.

On the second end region 1, opposite the first end region 3, of the shift lever heads 4, 4′, a pot-like receptacle 5 is formed coaxially. Receptacle 5 is open toward the second end region 1 and leads to the outside.

The receptacle 5 is of stepped construction and has a circumferential shoulder 6 at its outer edge at the point where the step which is nearer to the mouth and has a larger cross section joins the step with a smaller cross section.

In the center of receptacle 5, a support 8, which extends to a plane of the shoulder 6, protrudes from the base 7 of the receptacle 5.

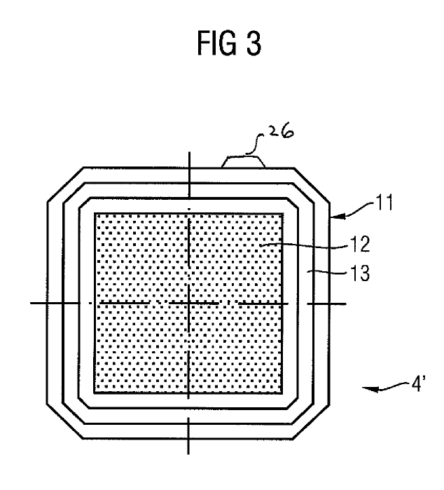

The cross section of the shift lever head 4 and of the receptacle 5 in FIGS. 1 and 2 is circular. The cross section of shift head 4′ is square as shown in FIG. 3, with the corners of the shift lever head 4′ being chamfered.

Of course, the shift lever head and/or receptacle can also have any other cross section.

A touch-sensitive input unit 9, whose height corresponds to the axial length of the step forming shoulder 6, with a relatively large cross section in the receptacle 5 and which has a cross section which corresponds to this cross section rests on the shoulder 6 and the support 8. The surface of the input unit 9 which is directed outward is a touch-sensitive input surface 12, which at the same time forms a display surface. Additional control elements 26, 28 can be arranged on the shift lever heads 4, 4′ or the shift lever 22.

A radially circumferential groove 10 with a half-dovetail cross section is formed at the region of the mouth of the receptacle 5, into which groove 10 the correspondingly formed end of a securing ring 11 engages, which securing ring 11 protrudes axially on the side facing away from the second end region 3, with the result that a distance is present between the input surface 12 and the end-side outer surface 13 of the securing ring 11. In one embodiment, the securing ring includes illuminating elements 20. In one embodiment, the securing ring 11 is a switching ring that provides further operator control.

Its end-side inner surface 14 projects radially inward beyond the circumferential edge 15 of the input unit 9 and rests axially on the edge 15, with the result that the input unit 9 is secured in its illustrated installation position.

The shift lever with the shift lever head 4, 4′ is preferably arranged in the region of a center console between the driver's seat and the front seat passenger seat in the motor vehicle. However, arrangement at another suitable location is also possible.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A shift lever head comprising:
a body having a first end region and a second end region opposite the first end region, the first end region configured to be attached to a shift lever adapted to activate a transmission of a motor vehicle;
a receptacle formed in the second end region of the body; and
an input unit comprising at least one of a touch-sensitive input surface and a proximity-sensitive input surface arranged in the receptacle.

13. The shift lever head as claimed in claim 12, wherein the at least one of the touch-sensitive input surface and the proximity-sensitive input surface is arranged in the receptacle at a distance from a mouth of the receptacle.

14. The shift lever head as claimed in claim 12, wherein the input unit is a touchpad.

15. The shift lever head as claimed in one claim 12, wherein the at least one of the touch-sensitive input surface and the proximity-sensitive input surface further comprises a display surface.

16. The shift lever head as claimed in claim 12, wherein the at least one of the touch-sensitive input surface and the proximity-sensitive input surface or the mouth of the receptacle is surrounded by an illuminated ring.

17. The shift lever head as claimed in claim 13, wherein a securing ring is arranged at the mouth of the receptacle, the securing ring configured to surround the at least one of the touch-sensitive input surface and the proximity-sensitive input surface and rest on a circumferential edge of the input unit,
whereby the at least one of the touch-sensitive input surface and the proximity-sensitive input surface is secured it in its installation position.

18. The shift lever head as claimed in claim 16, wherein a securing ring configured to secure the at least one of the touch-sensitive input surface and the proximity-sensitive input surface in the receptacle forms the illuminated ring.

19. The shift lever head as claimed in claim 12, wherein further operator control elements are arranged on at least one of the body and the shift lever.

20. The shift lever head as claimed in claim 19, wherein at least one of the at least one of the touch-sensitive input surface and the proximity-sensitive input surface and the mouth of the receptacle is surrounded by a switching ring, which forms an operator control element.

21. The shift lever head as claimed in claim 19, wherein keys configured to form the operator control elements are arranged at least one of axially and radially on the body.

22. The shift lever head as claimed in claim 19, wherein keys, which form the operator control elements, are arranged radially on the shift lever.

23. The shift lever head as claimed in claims 18, wherein the securing ring forms an illuminated ring configured to illuminate the at least one of the touch-sensitive input surface and the proximity-sensitive input surface.

24. The shift lever head as claimed in claim 18, wherein the securing ring has a dove-tail shaped cross section.

25. The shift lever head as claimed in claim 18, wherein the input unit is supported by a support post in the receptacle.

26. The shift lever head as claimed in claim 12, wherein the input unit is arranged on the shift lever head in a portion that is covered by a drivers hand during a transmission shifting operation, whereby the input surface is not unintentionally activated.
